(19) United States
(12) Patent Application Publication
(10) Pub. No.: US 2012/0125837 A1
(43) Pub. Date: May 24, 2012

(54) ANAEROBIC DIGESTION PROCESS AND APPARATUS

(75) Inventor: John Anderson James Mullett, Cambridgeshire (GB)

(73) Assignee: BIO GROUP LIMITED, Cambridgeshire (GB)

(21) Appl. No.: 13/388,436

(22) PCT Filed: Jul. 30, 2010
(86) PCT No.: PCT/GB10/51260

§ 371 Date: Feb. 6, 2012

(30) Foreign Application Priority Data
Aug. 4, 2009 (GB) 0913575.7

(51) Int. Cl. C02F 3/28

(52) U.S. Cl. 210/601; 210/97

(57) ABSTRACT

Apparatus (10) for anaerobic digestion of organic waste, comprises a reaction chamber (12) and a gas pressure regulator (14). The reaction chamber (12) comprises a first cell (20) and a second cell (22) linked by a passageway (24) for flow of organic waste slurry from a lower or bottom region of one cell to a lower or bottom region of another cell. The second cell is configured to retain gas under pressure in order to displace organic waste slurry through the passageway (24) from the second cell (22) to the first cell (20) in order to build a head of organic waste slurry in the first cell (20). The gas pressure regulator (14) is configured to release pressurized gas from the second cell in order to discharge the head of organic waste slurry from the first cell (20) back to the second cell (22) and agitate organic waste slurry in the reaction chamber (12).

### TECHNICAL FIELD

The present invention relates to a method of anaerobically digesting organic material, and to apparatus for anaerobic digestion of organic material.

### BACKGROUND ART

Anaerobic digestion is a process whereby organic waste is broken down in a controlled, oxygen-free environment by bacteria naturally occurring in the waste material. Methane-rich biogas is produced, thus facilitating renewable energy generation. There is great interest in optimising anaerobic digestion of organic waste in order to increase such renewable energy generation.

There are certain problems associated with anaerobic digestion of organic waste (e.g. food waste or animal manures with straw bedding) which are soup or paste-like; that is, organic waste which is neither solid nor low-viscosity liquid, but instead a liquid containing high solids (perhaps up to 25% by weight). Such organic waste “slurries” have a tendency to separate into three phases if left standing during anaerobic digestion. Larger solid particles of organic waste have a tendency to settle to form a sediment phase. On the other hand, smaller particles of organic waste have a tendency to float to form a foam like raft, particularly due to generated biogas becoming trapped on the surface of such particles.

In this way, a layer of liquid, depleted of solid matter, might form between the foam-like raft and sediment phase. In order to avoid such separation, various steps have been proposed to agitate the slurry during the anaerobic digestion process. These steps include: the use of paddles to stir the slurry; the use of pumps to keep the slurry flowing; and bubbling collected biogas through the slurry.

A system has been proposed which uses biogas production to displace slurry from one cell to another in a twin cell reactor. However, such displacement is relatively slow and does not prevent separation of the organic waste slurry into three phases.

The present applicant has previously sought to address some of the problems associated with processing organic waste slurries, and in WO 2009/068845 proposed a method and apparatus for anaerobically digesting organic material. The method comprised: providing a reaction chamber comprising first and second cells linked by a passageway for flow of organic waste slurry from a bottom region of one cell to a bottom region of another cell; placing an organic waste slurry in the reaction chamber to fill at least the bottom region of each cell; displacing organic waste slurry in the second cell; and discharging the head of organic waste slurry from the second cell to agitate organic waste slurry in the reaction chamber.

The present applicant has now sought to provide a modified method and apparatus for anaerobically digesting organic material which may be installed and/or operated more easily, and if necessary without requiring any power supply to agitate the organic material during anaerobic decomposition.

### DISCLOSURE OF INVENTION

### First Invention (Claims 1-15)

In accordance with a first aspect of the present invention, there is provided apparatus for anaerobic digestion of organic waste, comprising: a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell; and a gas pressure regulator for releasing pressurized gas from the second cell in order to discharge the head of organic waste slurry from the first cell to the second cell and agitate organic waste slurry in the reaction chamber, wherein the gas pressure regulator is configured to release pressurized gas from the second cell when the pressure exceeds a predetermined value.

The present applicant has devised standalone apparatus which may be readily installed and commissioned so that processing of organic waste may commence as soon as possible. By having a gas pressure regulator which is configured to only release pressurized gas from the second cell when the pressure exceeds a predetermined value, the apparatus will automatically discharge the head of organic waste slurry when this has been built to a sufficient degree to warrant discharging.

The first cell may have different dimensions to the second cell such that a level of organic waste slurry in the first cell increases more quickly than a corresponding level of organic waste slurry in the second cell decreases when building the head of organic waste slurry in the first cell.

The apparatus may comprise at least one agitation device in the second cell which, in use, is at least partially submerged in organic waste slurry in the reaction chamber.

In accordance with a second aspect of the present invention, there is provided a method of anaerobically digesting organic material, comprising: providing a reaction chamber comprising first and second cells linked by a passageway for flow or organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; discharging the head of organic waste slurry from the first cell to the second cell to agitate waste slurry in the reaction chamber, wherein the head of organic waste slurry is discharged by releasing pressurized gas from the second cell when the pressure exceeds a predetermined value.

The second cell may be pressurized relative to the first cell by biogas generated by anaerobic decomposition of organic waste slurry in the second cell.

Embodiments of the first aspect of the invention may equally be considered embodiments of the second aspect of the invention.

### Second Invention (Claims 16-30)

In accordance with a third aspect of the present invention there is provided apparatus for anaerobic digestion of organic waste, comprising: a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell; and a gas pressure regulator for releasing pressurized gas from the second cell in order to discharge the head of organic waste slurry from the first cell to the second cell and agitate organic waste slurry in the reaction chamber, wherein the first cell has different dimensions to the second cell such that a level of organic waste slurry in the first cell increases more quickly than a corresponding level of organic waste slurry in the second cell decreases when building the head of organic waste slurry in the first cell.

The present applicant has appreciated that by making the first and second cells different sizes and/or shapes, it is possible to build the head of organic waste slurry in the first cell more quickly than with first and second cells which are the same size. Thus, over a given period of time, the head may be discharged more frequently than might otherwise be the case with first and second cells which are the same size and shape, with a resultant improvement in agitation of the organic waste slurry. Alternatively or additionally, a larger head of organic waste slurry may be discharged than might otherwise be the case with first and second cells which are the same size and shape, again with a resultant improvement in agitation of the organic waste slurry. Furthermore, such a configuration encourages a greater flow of discharged organic waste slurry substantially horizontally along the reaction chamber (in a direction from the first cell to the second cell) than might otherwise be the case with first and second cells which are the same size and shape.

The gas pressure regulator may be configured to release pressurized gas from the second cell when the pressure exceeds a predetermined value. Such an arrangement allows the head of organic waste slurry to build without interruption.

The apparatus may comprise at least one agitation device in the second cell which, in use, is at least partially submerged in organic waste slurry in the reaction chamber.

In accordance with a fourth aspect of the present invention, there is provided a method of anaerobically digesting organic material, comprising: providing a reaction chamber comprising first and second cells linked by a passageway for flow of organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; discharging the head of organic waste slurry from the first cell to the second cell to agitate waste slurry in the reaction chamber, wherein the first and second cells have different dimensions such that a level of organic waste slurry in the first cell increases more quickly than a corresponding level of organic waste slurry in the second cell decreases when building the head of organic waste slurry in the first cell.

The second cell may be pressurized relative to the first cell by biogas generated by anaerobic decomposition of organic waste slurry in the second cell.

Embodiments of the third aspect of the invention may equally be considered embodiments of the fourth aspect of the invention.

### Third Invention (Claims 31-45)

In accordance with a fifth aspect of the present invention, there is provided apparatus for anaerobic digestion of organic waste, comprising: a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell; a gas pressure regulator for releasing pressurized gas from the second cell in order to discharge the head of organic waste slurry from the first cell to the second cell and agitate organic waste slurry in the reaction chamber; and at least one agitation device in the second cell which in use is at least partially submerged in organic waste slurry in the reaction chamber.

The present applicant has appreciated that an agitation device in the second cell may help to denature any foam-like raft generated during anaerobic decomposition of the organic waste slurry, by introducing further turbulence during discharge of the head of organic waste slurry.

The first cell may have different dimensions to the second cell such that a level of organic waste slurry in the first cell increases more quickly than an corresponding level of organic waste slurry in the second cell decreases when building the head of organic waste slurry in the first cell.

The gas pressure regulator may be configured to release pressurized gas from the second cell when the pressure exceeds a predetermined value.

In accordance with a sixth aspect of the present invention, there is provided a method of anaerobically digesting organic material, comprising: providing a reaction chamber comprising first and second cells linked by a passageway for flow or organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; discharging the head of organic waste slurry from the first cell to the second cell to agitate waste slurry in the reaction chamber, further comprising providing at least one agitation device in the second cell, the at least one agitation device imparting turbulence to organic waste slurry flowing therethrough when the head of organic waste slurry is discharged.

The second cell may be pressurized relative to the first cell by biogas generated by anaerobic decomposition or organic waste slurry in the second cell.

Embodiments of the fifth aspect of the invention may equally be considered embodiments of the sixth aspect of the invention.

### All Inventions

The first cell may have different dimensions to the second cell such that the level of organic waste slurry in the first cell increases at least twice as quickly (possibly even at least four times more quickly) as the corresponding level of organic waste slurry in the second cell decreases when building the head of organic waste slurry in the first cell. For example, assuming a constant cross-section, the second cell may be at least twice as long (possibly about four times as long and possibly even about twenty times as long) as the first cell.

The gas pressure regulator may be configured to release substantially all gas under pressure from the second cell when the pressure exceeds the predetermined value, whereafter the gas pressure regulator once again prevents release of further gas from the second cell until the pressure next exceeds the predetermined value. In this way, the head of organic waste slurry may be quickly and fully discharged in one go, maximising the backflushing action. Furthermore, once the head has been discharged, there is no unnecessary delay in building a subsequent head of organic waste slurry in the first cell. The gas pressure regulator may comprise a U-tube in fluid communication with a header tank, with liquid (e.g. oil) in the U-tube being displaced into the header tank by pressurized gas in the second cell. When substantially all gas under pressure has been released from the second cell, displaced liquid may flow back into the U-tube from the header tank. In this way, the gas pressure regulator resets itself automatically after the head of organic waste slurry is discharged.

The gas pressure regulator may further comprise: a member defining a chamber with an opening in fluid communication with liquid in the header tank and with a vent for venting gas in the chamber, the member being configured to float in the liquid when gas accumulates in the chamber and to sink in the liquid when liquid fills the chamber; and a guide for guiding reciprocal movement of the member in the header tank between a first position submerged in the liquid in the tank and a second position floating in the tank. The U-tube is configured to deliver gas from the second cell to the chamber of the member.

When a threshold pressure is exceeded, there is a sudden and substantial flow of gas from the second cell which displaces liquid from the chamber, causing the member to float from the second position to the first position. The member continues to float until the flow of gas from the chamber through the vent exceeds the flow of gas into the chamber from the U-tube (which indicates that the gas pressure in the second cell has been substantially relieved). As the chamber fills with liquid through the second opening, the member will sink back to the first position, and the reciprocating cycle is ready to repeat once the pressure in the second cell exceeds the threshold once again.

The at least one agitation device may be static, and may comprise a plurality of spaced-apart elongate members forming a screen. The screen may be aligned substantially transversely to flow of discharged organic waste slurry substantially horizontally along the reaction chamber. In this way, a degree of turbulence is introduced into the otherwise organic waste slurry on passing through the gaps between elongate members of the screen. A plurality of agitation devices may be aligned in series in the second cell.

The first cell may remain open to ambient conditions during anaerobic digestion of organic waste (which occurs predominantly in the second cell). In this way, organic waste slurry may be fed into the reaction chamber, whilst a head of organic waste slurry is being built or discharged (i.e. at any time), and may thus be fed continuously or in batches. Alternatively, the first cell may be closed to ambient conditions during anaerobic digestion of organic waste, so long as means are provided for preventing a build-up of gas under pressure in the first cell as a head of organic waste slurry is being built. For example, gas in the first cell may communicate with gas in an enclosure (e.g. header tank) whose pressure is below that in the second cell. In this way, it is possible to control odours generated by the reaction chamber during use. The second cell may comprise one part with a greater headroom than adjacent parts, with the gas pressure regulator being mounted in said one part. In this way, the gas pressure regulator is less likely to be compromised by any foam-like raft generated during anaerobic digestion of the organic waste slurry. In any event, the reaction chamber may be configured to withstand an internal pressure which is greater than that required to displace organic waste slurry from the second cell, through the first cell, and out of the reaction chamber. In other words, such apparatus would have a “fail safe” design in the event the gas pressure regulator failed.

The reaction chamber may have a substantially circular cross-section along at least a substantial part of its length (i.e. in a direction from the first cell to the second cell). For example, the reaction chamber may have a substantially cylindrical body which in use is aligned substantially horizontally. The substantially circular cross-section may help with denaturing of any foam-like raft generated during anaerobic digestion of the organic waste slurry as the level of organic waste slurry rises and falls. This is because the surface area of such a foam-like raft will be forced to change by the internal surface of the reaction chamber as the slurry level changes, alternatively compressing and stretching the foam-like raft.

### Gas Pressure Regulator

In accordance with yet another aspect of the present invention, there is provided a gas pressure regulator, comprising: a tank containing liquid; a member defining a chamber with an opening in fluid communication with liquid in the tank and with a vent for venting gas from the chamber, the member being configured to float in the liquid when gas accumulates in the chamber and to sink in the liquid when liquid fills the chamber; a guide for guiding reciprocal movement of the member in the tank between a first position submerged in the liquid in the tank and a second position floating in liquid in the tank; and a gas input line for delivering gas from a source being regulated to the chamber.

The gas pressure regulator is designed to work automatically and without requiring a power supply or a complex control system. Reciprocation of the member allows gas from a source (such as the second cell defined in the preceding aspects of the invention) to be cyclically accumulated and discharged in dependence upon its pressure. This may be very important where gas pressure build-up may not always be uniform, which may well be the case in apparatus for anaerobic decomposition of organic material.

The opening may be in a lower region of the chamber, whilst the vent may be in an upper region of the chamber, when the gas pressure regulator is in use. In this way, gas delivered to the chamber will be able to displace liquid from the chamber out through the opening. The member may be cup-like, and may be inverted in the tank such that a rim of the cup defines the opening.

The gas input line may have a profile (e.g. U-shaped) at its downstream end which may be submerged in the liquid and is configured to encourage a pronounced and prolonged flow of gas from the source into the chamber, as opposed to a steady “seepage” flow, when a threshold pressure is exceeded. Such a profile may generate a venturi effect once the threshold gas pressure is exceeded, drawing further gas from the source even if the threshold pressure is no longer exceeded. The threshold pressure may be varied by varying the depth of liquid in the tank and/or the position of the profile relative to the surface level of liquid in the tank.

### BRIEF DESCRIPTION OF DRAWINGS

An embodiment of the invention will now be described by way of example and with reference to the accompanying drawings, in which:

FIG. 1 is a schematic sectional view of apparatus embodying the invention;

FIG. 2 is a section view along the line AA in FIG. 1;

FIG. 3 is a schematic view of the apparatus of FIG. 1 in use, as a head of fluid is building;

FIG. 4 is a schematic view of the apparatus of FIG. 1, as a head of fluid is being discharged; and

FIGS. 5A and 5B show schematic views of an alternative gas pressure regulator to the one shown in FIGS. 1, 3 and 4.

### DETAILED DESCRIPTION OF SPECIFIC EMBODIMENT

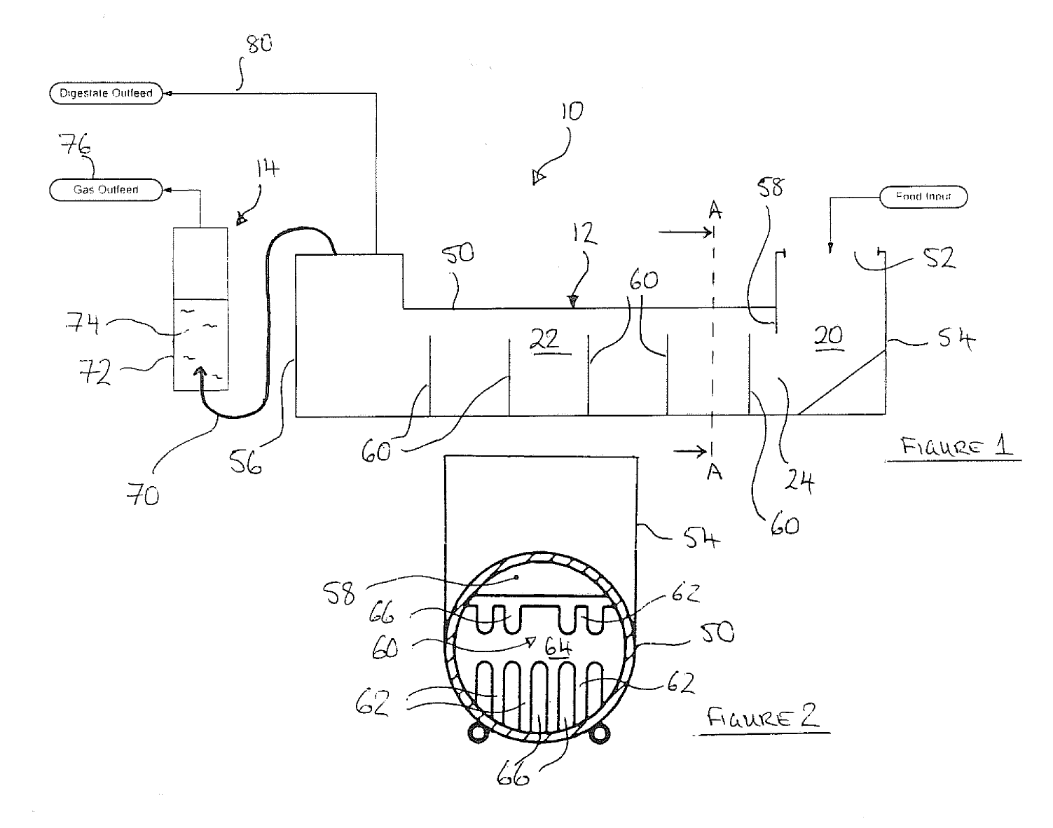

FIG. 1 is a schematic sectional view of apparatus 10 for anaerobic digestion of organic waste, comprising a reaction chamber 12 and a gas pressure regulator 14. The reaction chamber 12 comprises a first cell 20 and a second cell 22 linked by a passageway 24 for flow of organic waste slurry from a lower or bottom region of one cell to a lower or bottom region of another cell. The second cell is configured to retain gas under pressure in order to displace organic waste slurry through the passageway 24 from the second cell 22 to the first cell 20 in order to build a head of organic waste slurry in the first cell 20, The gas pressure regulator 14 is configured to release pressurized gas from the second cell in order to discharge the head of organic waste slurry from the first cell 20 back to the second cell 22 and agitate organic waste slurry in the reaction chamber 12.

The reaction chamber 12 is formed from a cylindrical body 50, perhaps 3.5 m in diameter. End sections of the cylindrical body 50 are cut at 45° to its longitudinal axis, rotated through 180°, and then joined back to the remaining body 50 to form turret-like extensions 54, 56. At the inlet end of the reaction chamber 12, turret-like extension 54 has an opening 52 for receiving organic waste slurry for processing; at the downstream end of the reaction chamber 12, turret-like extension 56 is sealed to retain gas under pressure. The cylindrical body 50 is divided by a baffle 58 depending from an upper part of the reaction chamber 12, forming passageway 24 and defining the first and second cells 20, 22. The baffle 58 is positioned such that the second cell 22 is significantly larger than the first cell 20.

The second cell 22 includes five agitation combs 60, spaced axially along the cylindrical body 50. (The actual number of combs 60 will depend to some extent on the overall length of the reaction chamber 12, and may well be considerably more than five). Each agitation comb 60 comprises a plurality of spaced-apart, elongate members 62 forming a screen 64 aligned transversely to the longitudinal axis of the cylindrical body 50. The elongate members 62 have a profile which impedes flow of organic waste slurry along the cylindrical body 50, and are designed to induce turbulence in organic waste slurry flowing through the gaps 66 therebetween. The agitation combs 60 are static and are secured to the cylindrical body 50 where they will be submerged in organic waste slurry.

The gas pressure regulator 14 comprises a U-tube 70 in fluid communication with a header tank 72, such that both contain a liquid 74 such as oil. The U-tube 70 is coupled to the top of turret-like extension 56 such that pressurized gas in the second cell 22 is able to displace liquid 74 from the U-tube 70 into the header tank 72. When pressurized gas in the second cell 22 exceeds a predetermined or threshold value, substantially all pressurized gas in the second cell 22 is released through the U-tube 70 and header tank 72 where it is collected in gas outfeed 76. Thereafter, liquid 74 in the header tank 72 drains back into the U-tube 70, resetting the gas pressure regulator 14, and allowing gas pressure to build once again in the second cell 22.

An outlet 80 is provided for removing processed organic waste slurry from the second cell 22. The outlet 80 is shown schematically in FIG. 1 as extending from turret-like extension 56. However, in one form (not shown), the outlet 80 may be a conduit extending from a downstream end of the reaction chamber 12, through the second cell 22, through the first cell 20, and out of the reaction chamber 12, possibly through the opening 52 in turret-like extension 54.

The apparatus 10 is loaded with an organic waste slurry (S) to be processed. The organic waste slurry (S) is poured into the first cell 20 through opening 52, until the level of organic waste slurry (S) through the reaction chamber 12 is equivalent to L (which is higher than the lower end of baffle 58). Anaerobic digestion of organic waste slurry (S) produces biogas which collects in the second cell 22, displacing organic waste slurry (S) from the second cell 22, through the passageway 24, building a head (H) of organic waste slurry (S) in the first cell 20. Due to the asymmetry of the cells 20, 22, the fluid level in the second cell 22 falls by an amount ΔL2 which is significantly less than the amount ΔL1 which the fluid level in the first cell 20 increases. When the pressure of gas in the second cell 22 exceeds a predetermined level, the gas pressure regulator 14 rapidly releases pressurized gas from the second cell 22, discharging the head (H) of organic waste slurry (S). The fluid level in the first cell 20 rapidly falls (in direction of arrows A) towards L as the head (H) is discharged, giving rise to a backflushing action which agitates the organic waste slurry (S). The asymmetry of the cells 20, 22 gives rise to a predominantly horizontal flow (in direction of arrows B) of organic waste slurry (S) along the second cell 22 and through agitation combs 60. A chute 82 at the bottom of turret-like extension 54 may act as a deflector plate, helping to direct flowing fluid from the head of organic waste slurry (S) along the second cell 22. Once the pressurized gas in second cell 22 has been released, the gas pressure regulator 14 is reset and the cycle repeats itself again and again, until the decomposition of the organic waste slurry (S) is complete,

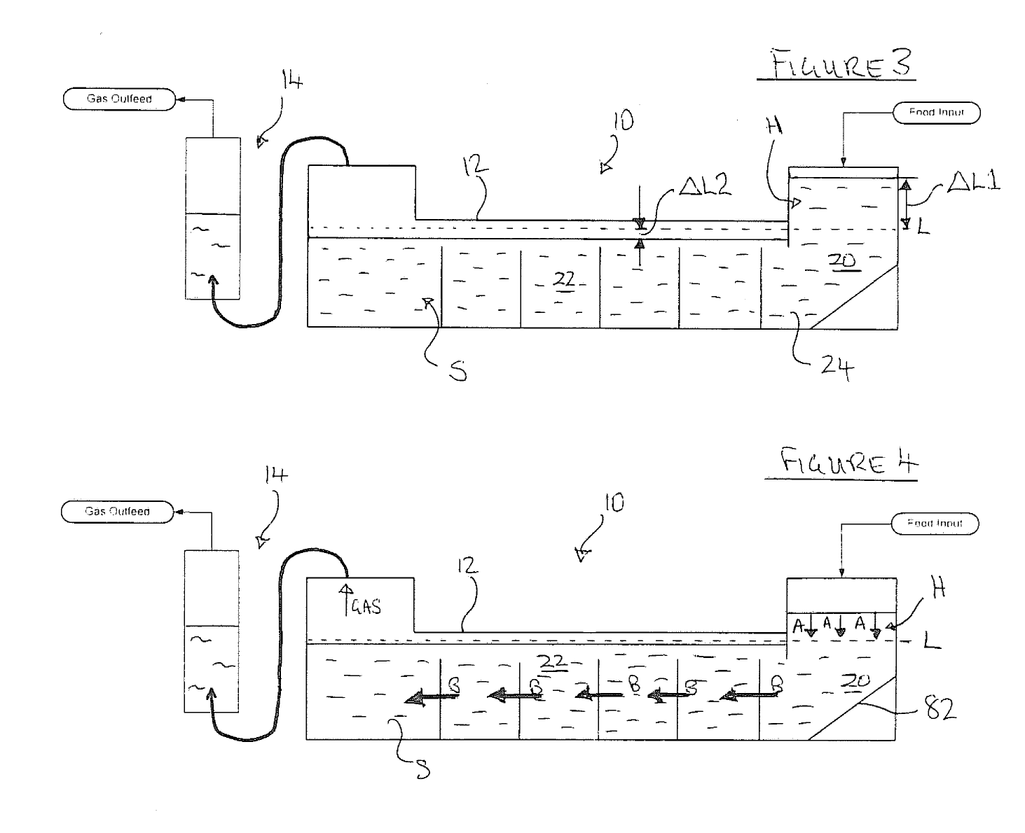

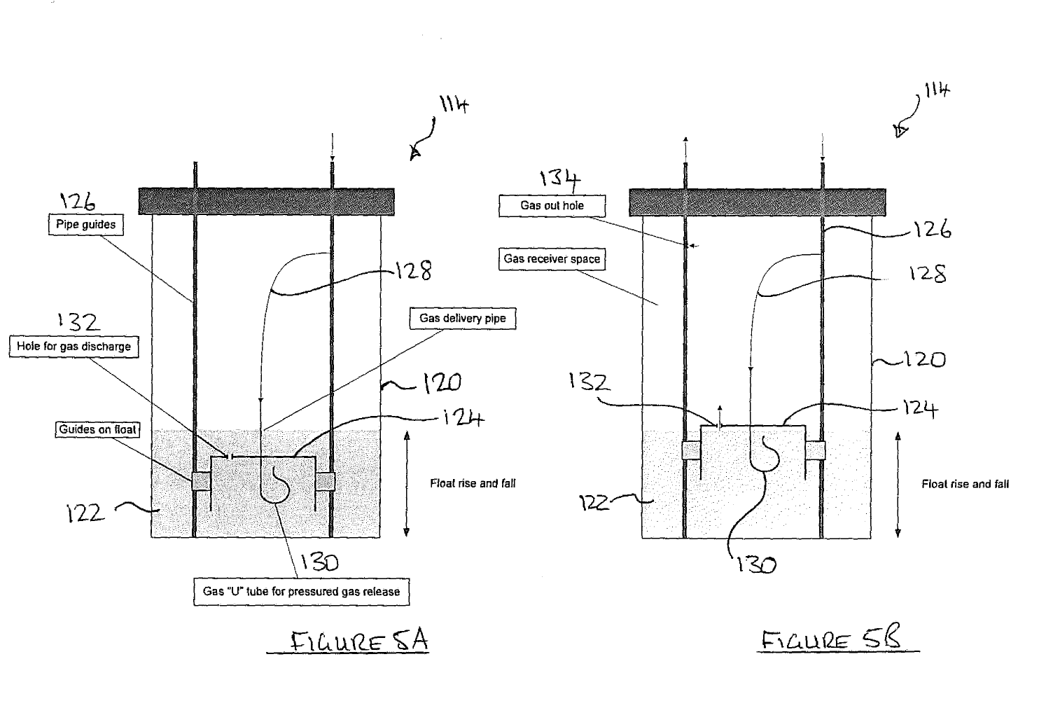

FIGS. 5A and 5B illustrate an alternative gas pressure regulator 114 which may be used in place of the gas pressure regulator 14 in FIGS. 1, 3 and 4. The gas pressure regulator 114 comprises a tank 120 part filled with liquid 122. The tank 120 houses an inverted cup-like member 124 which reciprocates along pipe guides 126. The cup-like member 124 is configured to receive biogas from the second cell 22 via a gas delivery hose 128 which has a “U-tube” profile 130 at its free end. The cup-like member 124 also has an aperture 132 for discharge of biogas received via the gas delivery hose 128; the aperture 132 is small relative to the bore of the gas delivery hose 128. The “U-tube” profile 130 initially prevents biogas generated in the second cell 22 from being discharged in the tank 120. With no gas trapped within it, the cup-like member 124 sinks into the liquid 122 under its own weight (as shown in FIG. 5A). However, when the pressure in the second cell 22 exceeds a predetermined level (sufficient to displace liquid in the U-tube profile 130), there is a sudden and prolonged release of biogas into the cup-like member 124 via the hose 128, due to a venturi effect created by the U-tube profile 130. The biogas fills the cup-like member 124 faster than it can escape through the aperture 132, causing the cup-like member 124 to become buoyant and slide up pipe guides 126 (as shown in FIG. 5B).

Any biogas released through the aperture 132 may be recovered from the tank 120 through gas outlet 134. Once the pressure in the second cell 22 has reduced, the flow of bio-gas through the hose 128 will case. As biogas trapped in cup-like member 1245 continues to escape through the aperture 132, the cup-like member 124 will sink to the position shown in FIG. 5A, resetting the gas pressure regulator 114. The level of gas pressure in the second cell 22 which is required to trigger the sudden and prolonged release of biogas into the cup-like member 124 via the hose 128 may be adjusted by varying the level of liquid 122 in the tank 120.

1. Apparatus for anaerobic digestion of organic waste, comprising:
a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell; and
a gas pressure regulator for releasing pressurized gas from the second cell in order to discharge the head of organic waste slurry from the first cell to the second cell and agitate organic waste slurry in the reaction chamber, wherein the gas pressure regulator is configured to release pressurized gas from the second cell when the pressure exceeds a predetermined value.

2. Apparatus according to claim 1, in which the gas pressure regulator is configured to release substantially all pressurized gas from the second cell when the pressure exceeds the predetermined value, whereupon the gas pressure regulator prevents release of further gas from the second cell until the pressure next exceeds the predetermined value.

3. Apparatus according to claim 1 or claim 2, in which the gas pressure regulator comprises a U-tube in fluid communication with a header tank, with fluid in the U-tube being displaced into the header tank by pressurized gas in the second cell.

4. Apparatus according to claim 3, in which the gas pressure regulator further comprises: a member defining a chamber for receiving pressurized gas from the second cell, the chamber having an opening in fluid communication with liquid in the header tank and a vent for venting gas in the chamber, the member being configured to float in the liquid when gas accumulates in the chamber and to sink in the liquid when liquid fills the chamber; and a guide for guiding reciprocal movement of the member in the header tank between a first position submerged in the liquid in the tank and a second position floating in the tank.

5. Apparatus according to any one of the preceding claims, wherein the first cell has different dimensions to the second cell such that a level of organic waste slurry in the first cell increases more quickly than a corresponding level of organic waste slurry in the second cell decreases when building the head of organic waste slurry in the first cell.

6. Apparatus according to claim 5, in which the first cell has different dimensions to the second cell such that the level of organic waste slurry in the first cell increases at least twice as quickly as the corresponding level of organic waste slurry in the second cell decreases when building the head of organic waste slurry in the first cell.

7. Apparatus according to any one of the preceding claims, further comprising at least one agitation device in the second cell which in use is at least partially submerged in organic waste slurry in the reaction chamber.

8. Apparatus according to claim 7, in which the or each agitation device comprises a plurality of spaced-apart elongate members forming a screen.

9. Apparatus according to any one of the preceding claims, in which the second cell comprises one part with greater headroom than adjacent parts, the gas pressure regulator being mounted in the one part.

10. Apparatus according to claim 9, in which the said one part may be configured as a turret.

11. Apparatus according to any one of the preceding claims, in which the reaction chamber is formed from a cylindrical member, which in use is aligned substantially horizontally.

12. Apparatus according to any one of the preceding claims, comprising a conduit for extracting digested organic waste from the second cell, the conduit extending from the second cell through the first cell, to a position outside the reaction chamber.

13. A method of anaerobically digesting organic material, comprising: providing a reaction chamber comprising first and second cells linked by a passageway for flow or organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; discharging the head of organic waste slurry from the first cell to the second cell to agitate waste slurry in the reaction chamber, wherein the head of organic waste slurry is discharged by releasing pressurized gas from the second cell when the pressure exceeds a predetermined value.

14. A method according to claim 13, in which the first and second cells have different dimensions such that a level of organic waste slurry in the first cell increases more quickly than a corresponding level of organic waste slurry in the second cell decreases when building the head of organic waste slurry in the first cell.

15. A method according to claim 13 or claim 14, further comprising providing at least one agitation device in the second cell, the at least one agitation device imparting turbulence to organic waste slurry flowing therethrough when the head of organic waste slurry is discharged.

16. Apparatus for anaerobic digestion of organic waste, comprising:
a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell; and
a gas pressure regulator for releasing pressurized gas from the second cell in order to discharge the head of organic waste slurry from the first cell to the second cell and agitate organic waste slurry in the reaction chamber,
wherein the first cell has different dimensions to the second cell such that a level of organic waste slurry in the first cell increases more quickly than a corresponding level of organic waste slurry in the second cell decreases when building the head of organic waste slurry in the first cell.

17. Apparatus according to claim 16, in which the first cell has different dimensions to the second cell such that the level of organic waste slurry in the first cell increases at least twice as quickly as the corresponding level of organic waste slurry in the second cell decreases when building the head of organic waste slurry in the first cell.

18. Apparatus according to claim 16 or claim 17, in which the gas pressure regulator is configured to release pressurized gas from the second cell when the pressure exceeds a predetermined value.

19. Apparatus according to claim 18, in which the gas pressure regulator is configured to release substantially all pressurized gas from the second cell when the pressure exceeds the predetermined value, whereupon the gas pressure regulator prevents release of further gas from the second cell until the pressure next exceeds the predetermined value.

20. Apparatus according to claim 18 or claim 19, in which the gas pressure regulator comprises a U-tube in fluid communication with a header tank, with fluid in the U-tube being displaced into the header tank by pressurized gas in the second cell.

21. Apparatus according to claim 20, in which the gas pressure regulator further comprises: a member defining a chamber for receiving pressurized gas from the second cell, the chamber having an opening in fluid communication with liquid in the header tank and a vent for venting gas in the chamber, the member being configured to float in the liquid when gas accumulates in the chamber and to sink in the liquid when liquid fills the chamber; and a guide for guiding reciprocal movement of the member in the header tank between a first position submerged in the liquid in the tank and a second position floating in the tank.

22. Apparatus according to any one of claims 16 to 21, further comprising at least one agitation device in the second cell which in use is at least partially submerged in organic waste slurry in the reaction chamber.

23. Apparatus according to claim 22, in which the or each agitation device comprises a plurality of spaced-apart elongate members forming a screen.

24. Apparatus according to any one of claims 16 to 23, in which the second cell comprises one part with greater headroom than adjacent parts, the gas pressure regulator being mounted in the one part.

25. Apparatus according to claim 24, in which the said one part may be configured as a turret.

26. Apparatus according to any one of claims 16 to 25, in which the reaction chamber is formed from a cylindrical member which in use is aligned substantially horizontally.

27. Apparatus according to any one of claims 16 to 26, comprising a conduit for extracting digested organic waste from the second cell, the conduit extending from the second cell through the first cell, to a position outside the reaction chamber.

28. A method of anaerobically digesting organic material, comprising: providing a reaction chamber comprising first and second cells linked by a passageway for flow or organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; discharging the head of organic waste slurry from the first cell to the second cell to agitate waste slurry in the reaction chamber, wherein the first and second cells have different dimensions such that a level of organic waste slurry in the first cell increases more quickly than a corresponding level of organic waste slurry in the second cell decreases when building the head of organic waste slurry in the first cell.

29. A method according to claim 28, in which the head of organic waste slurry is discharged by releasing pressurized gas from the second cell when the pressure exceeds a predetermined value.

30. A method according to claim 28 or claim 29, further comprising providing at least one agitation device in the second cell, the at least one agitation device imparting turbulence to organic waste slurry flowing therethrough when the head of organic waste slurry is discharged.

31. Apparatus for anaerobic digestion of organic waste, comprising:
a reaction chamber for receiving an organic waste slurry, the reaction chamber comprising first and second cells linked by a passageway for flow of organic waste slurry from a bottom region of one cell to a bottom region of another cell, with the second cell being configured to retain gas under pressure in order to displace organic waste slurry through the passageway from the second cell to the first cell in order to build a head of organic waste slurry in the first cell;
a gas pressure regulator for releasing pressurized gas from the second cell in order to discharge the head of organic waste slurry from the first cell to the second cell and agitate organic waste slurry in the reaction chamber; and
at least one agitation device in the second cell which in use is at least partially submerged in organic waste slurry in the reaction chamber.

32. Apparatus according to claim 31, in which the or each agitation device comprises a plurality of spaced-apart elongate members forming a screen.

33. Apparatus according to claim 31 or claim 32, wherein the first cell has different dimensions to the second cell such that a level of organic waste slurry in the first cell increases more quickly than a corresponding level of organic waste slurry in the second cell decreases when building the head of organic waste slurry in the first cell.

34. Apparatus according to claim 33, in which the first cell has different dimensions to the second cell such that the level of organic waste slurry in the first cell increases at least twice as quickly as the corresponding level of organic waste slurry in the second cell decreases when building the head of organic waste slurry in the first cell.

35. Apparatus according to any one of claims 31 to 34, in which the gas pressure regulator is configured to release pressurized gas from the second cell when the pressure exceeds a predetermined value.

36. Apparatus according to claim 35, in which the gas pressure regulator is configured to release substantially all pressurized gas from the second cell when the pressure exceeds the predetermined value, whereupon the gas pressure regulator prevents release of further gas from the second cell until the pressure next exceeds the predetermined value.

37. Apparatus according to claim 35 or claim 36, in which the gas pressure regulator comprises a U-tube in fluid communication with a header tank, with fluid in the U-tube being displaced into the header tank by pressurized gas in the second cell.

38. Apparatus according to claim 37, in which the gas pressure regulator further comprises: a member defining a chamber for receiving pressurized gas from the second cell, the chamber having .an opening in fluid communication with liquid in the header tank and with a vent for venting gas in the chamber, the member being configured to float in the liquid when gas accumulates in the chamber and to sink in the liquid when liquid fills the chamber; and a guide for guiding reciprocal movement of the member in the header tank between a first position submerged in the liquid in the tank and a second position floating in the tank.

39. Apparatus according to any one of claims 31 to 38, in which the second cell comprises one part with greater headroom than adjacent parts, the gas pressure regulator being mounted in the one part.

40. Apparatus according to claim 39, in which the said one part is configured as a turret.

41. Apparatus according to any one of claims 31 to 40, in which the reaction chamber is formed from a cylindrical member, which in use is aligned substantially horizontally.

42. Apparatus according to any one of claims 31 to 41, comprising a conduit for extracting digested organic waste from the second cell, the conduit extending from the second cell through the first cell, to a position outside the reaction chamber.

43. A method of anaerobically digesting organic material, comprising: providing a reaction chamber comprising first and second cells linked by a passageway for flow or organic waste slurry from a bottom region of one cell to a bottom region of another cell, with the second cell being configured to retain gas under pressure; placing an organic waste slurry in the reaction chamber to fill at least the bottom region of each cell; displacing organic waste slurry through the passageway from the second cell to the first cell by pressurizing the second cell relative to the first cell, and building a head of organic waste slurry in the first cell; and discharging the head of organic waste slurry from the first cell to the second cell to agitate waste slurry in the reaction chamber; further comprising providing at least one agitation device in the second cell, the at least one agitation device imparting turbulence to organic waste slurry flowing therethrough when the head of organic waste slurry is discharged.

44. A method according to claim 43, in which the head of organic waste slurry is discharged by releasing pressurized gas from the second cell when the pressure exceeds a predetermined value.

45. A method according to claim 43 or claim 44, wherein the first and second cells have different dimensions such that a level of organic waste slurry in the first cell increases more quickly than a corresponding level of organic waste slurry in the second cell decreases when building the head of organic waste slurry in the first cell.

46. A gas pressure regulator, comprising:
a tank containing liquid;
a member defining a chamber with an opening in fluid communication with liquid in the tank and with a vent for venting gas from the chamber, the member being configured to float in the liquid when gas accumulates in the chamber and to sink in the liquid when liquid fills the chamber;
a guide for guiding reciprocal movement of the member in the tank between a first position submerged in the liquid in the tank and a second position floating in liquid in the tank; and
a gas input line for delivering gas from a source being regulated to the chamber.

47. A gas pressure regulator according to claim 46, wherein the gas input line has a profile (e.g. U-shaped) at its downstream end which is configured to encourage a pronounced and prolonged flow of gas from the source into the chamber when a threshold pressure is exceeded.
